(19) United States
(12) Patent Application Publication
(10) Pub. No.: US 2011/0274859 A1
(43) Pub. Date: Nov. 10, 2011

(54) Fire starter

(76) Inventor: John Hauser, Glendora, CA (US)

(21) Appl. No.: 12/631,858

(22) Filed: May 8, 2010

(51) Int. Cl. B32B 29/08; B32B 1/08

(52) U.S. Cl. 428/34.2

(57) ABSTRACT

Applicant desires patent protection for new and innovative fire starter composed of specially folded and shaped paper.

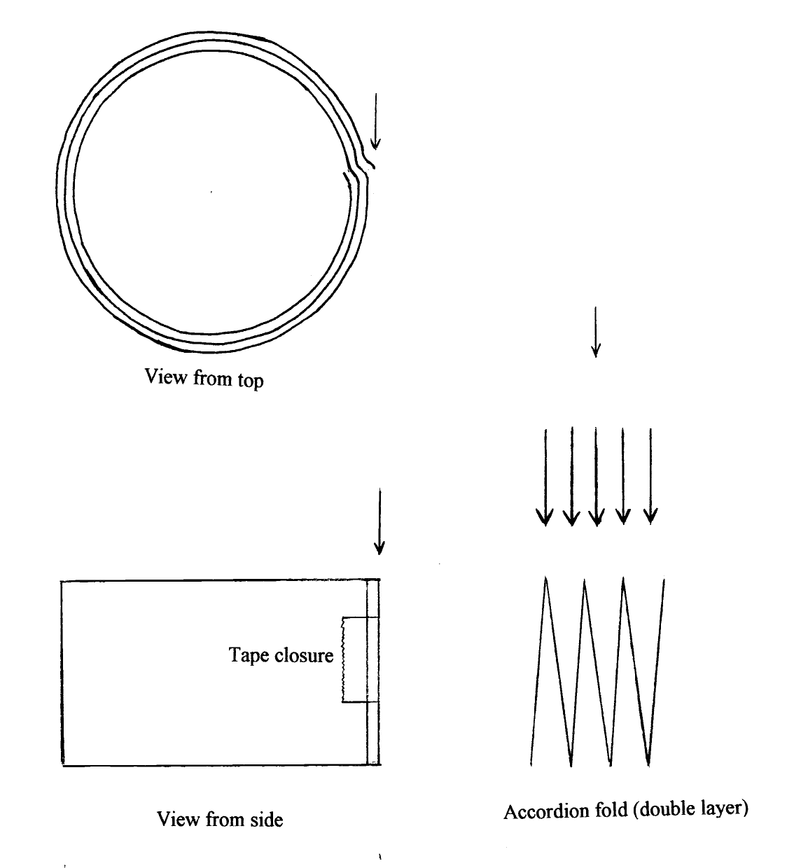

### CROSS-REFERENCE TO RELATED APPLICATIONS

The applicant is not aware of any prior provisional patent application(s) nor is the application is a continuation of a parent application number(s).

### STATEMENT REGARDING FEDERALLY SPONSORED RESEARCH (IF APPLICABLE)

The invention was not made under a government contract, nor was federal grant money used to fund the research.

### BACKGROUND OF THE INVENTION

Chimney starters now make starting a charcoal barbeque fire straightforward. Manufacturer instructions typically call for the placement of two sheets of crumpled paper in the bottom of the starter, loading the top portion with charcoal and setting the paper on fire with a match. More often than not, crumpled paper often results in a profusion of smoke and doesn't burn efficiently enough to ignite the charcoal. While other ignition devices have been developed for this purpose, usually in the form of cubes, tablets or packets loaded with or made of an accelerant, none match the simplicity and low-carbon footprint of a uniquely designed paper starter.

### SUMMARY OF THE INVENTION

The double-layered, specially folded and shaped paper quickly and efficiently ignites charcoal or another secondary fuel source, particularly when used in conjunction with widely available chimney starters.

### DESCRIPTION OF THE DRAWINGS

Three drawings; 1) a view of the device from the top labeled “View from top”; 2) a view of the device from the side labeled “View from side” and 3) a vertically expanded, detailed view of the double sheeted and layered paper and accordion fold labeled “Accordion fold (double layer)” accompanies this application.

### DETAILED DESCRIPTION OF THE INVENTION

A device comprised of:

a. double sheeted and layered paper, that is accordion folded, and radiolarian shaped and secured and stands about 1¾″ tall, with an inside diameter of about 2¼″ and an outside diameter of about 3″ whereby when ignited below or near charcoal, wood or other carbon based secondary fuel source, burns with an intensity sufficient to ignite the secondary fuel source.

### Sequence Listing

A sequence listing is not required.

### Abstract

Applicant desires patent protection for new and innovative fire starter composed of specially folded and shaped paper.

What is claimed as being new and desired to be protected by Letters Patent of the U.S. is as follows:

1. A new fire starting device for use in igniting charcoal, wood or other carbon based fuel comprised of a double sheeted and layered paper, that is accordion folded, radiolarian shaped and secured and stands about 1¾ inches tall, with an inside diameter of about 2¼ inches and an outside diameter of about 3 inches.
